(19) United States
(12) Patent Application Publication
(10) Pub. No.: US 2013/0272754 A1
(43) Pub. Date: Oct. 17, 2013

(54) DEVELOPING DEVICE

(71) Applicant: KABUSHIKI KAISHA TOSHIBA, Tokyo (JP)

(72) Inventor: Takumi Hatano, Kanagawa-ken (JP)

(73) Assignee: KABUSHIKI KAISHA TOSHIBA, Tokyo (JP)

(21) Appl. No.: 13/852,429

(22) Filed: Mar. 28, 2013

Related U.S. Application Data
(60) Provisional application No. 61/625,207, filed on Apr. 17, 2012.

(51) Int. Cl. G03G 15/08

(52) U.S. Cl. CPC G03G 15/0812
USPC 399/284

(57) ABSTRACT

According to one embodiment, a developing device includes a developer carrier arranged opposite to an image carrier on which an electrostatic latent image is formed and configured to supply toner for the electrostatic latent image and a toner layer regulating member configured to be pressed against the developer carrier to regulate the thickness of a toner layer on the developer carrier and the pressured surface of the developer carrier can be moved.

### CROSS-REFERENCE TO RELATED APPLICATIONS

This application is based upon and claims the benefit of priority from U.S. Provisional Application No. 61/625,207 filed on Apr. 17, 2012; the entire contents of which are incorporated herein by reference.

### FIELD

Embodiments described herein relate to a stable single-component nonmagnetic toner developing device capable of providing a high-definition image.

### BACKGROUND

Conventionally, a single-component developing device is structured with a fixed member for regulating a toner layer on a developing roller, for example, a plate-shaped (blade) member is propped against the developing roller.

However, as the developing device with such a structure is used, the fixation and pollution of the releasing agent (wax) and other low melting point material/pigment additives contained in toner to the blade and the abrasion of the blade as well as the inclusion of coarse large particles caused by inorganic oxide micro-particles lead to a problem that a poor-quality is generated due to the reduction in the supply quantity of partial toner or the poor electrification of toner.

### DESCRIPTION OF THE DRAWINGS

The accompanying drawings, which is incorporated in and constitute apart of this specification, illustrates an embodiment of the invention and together with the description, serve to explain the principles of the invention.

FIG. 1 is a diagram roughly showing an exemplary structure of an image forming apparatus according to an embodiment;

FIG. 2 is a diagram roughly showing the structure of the developing device shown in FIG. 1;

FIG. 3 is a diagram showing the main components of the developing device shown in FIG. 2.

### DETAILED DESCRIPTION

Reference will now be made in detail to the present embodiment of the invention, an example of which is illustrated in the accompanying drawing.

According to one embodiment, a developing device includes a developer carrier arranged opposite to an image carrier on which an electrostatic latent image is formed and configured to supply toner for the electrostatic latent image and a toner layer regulating member configured to be pressed against the developer carrier to regulate the thickness of a toner layer on the developer carrier and the pressured surface of the developer carrier can be moved.

According to one embodiment, an image forming apparatus includes an image carrier and a developing device for supplying toner to an electrostatic latent image formed on the image carrier, wherein the developing device includes a developer carrier configured to supply toner to the electrostatic latent image and a toner layer regulating member configured to be pressed against the developer carrier to regulate the thickness of a toner layer on the developer carrier and the pressured surface of the developer carrier can be moved.

The embodiment is described below with reference to accompanying drawings. Additionally, the same reference symbol used in the following description denotes the same structure or function.

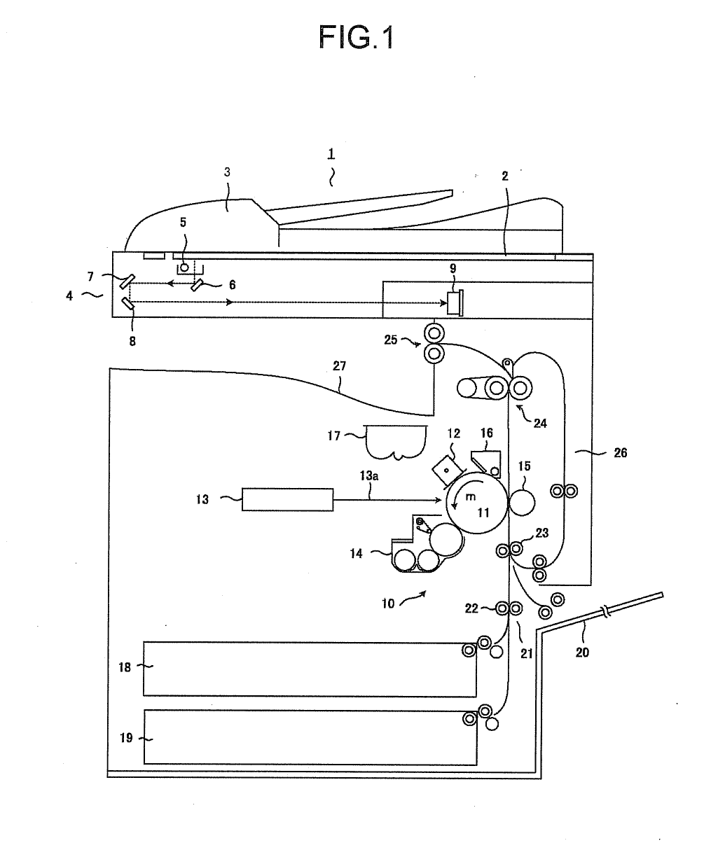

FIG. 1 is a diagram roughly showing an exemplary structure of an image forming apparatus according to the embodiment.

As shown in FIG. 1, an Original Document Platform 2 is arranged on the upper surface of the image forming apparatus 1. An automatic original feeder 3 is arranged on the upper part of the Original Document Platform 2, and a scanner 4 is arranged on the lower part of the Original Document Platform 2 to expose the original held on the e Original Document Platform 2 or the original fed by the automatic original feeder 3. The scanner 4 comprises a light source 5 for irradiating light towards the original, a first reflecting mirror 6 for reflecting the light reflected from the original to a given direction, a second and third reflecting mirrors 7 and 8 for reflecting the light reflected from the first reflecting mirror 6 orderly, and a light receiving element 9 for receiving the light reflected by the third reflecting mirror 8.

An image forming unit 10 is formed in the internal center of the image forming apparatus 1. The image forming unit 10 is provided with a photoconductive drum 11 which rotates freely in a direction indicated by an arrow m to serve as an image carrier. A charger 12 for charging the surface of the photoconductive drum 11 uniformly, a laser unit 13 for forming an electrostatic latent image on the surface of the photoconductive drum 11, a developing device 14 for supplying toner for the electrostatic latent image on the photoconductive drum 11, a transfer roller 15 for transferring a toner image on the photoconductive drum 11 onto a transfer image receiving object such as paper and a cleaner 16 for removing and recycling the residual toner left on the photoconductive drum 11 instead of transferred to the paper are sequentially arranged around the photoconductive drum 11 along the rotation direction of the photoconductive drum 11. A single-component nonmagnetic toner is accommodated in the developing device 14.

The nonmagnetic toner is a single-component nonmagnetic toner containing polyester resin, a coloring agent, a charge control agent, wax and hydrophobic silica.

For the sake of the low-temperature fixation property of the toner, the polyester resin should be the combination of a non-crystalline resin with a crystalline resin. The raw monomers of the polyester resins may be, for example, an alcohol component having a valence of above 2 and a carboxylic acid component a having a valence of above 2 such as carboxylic acid, carboxylic acid anhydride and carboxylic acid ester. The coloring agent may be, for example, carbon black, organic or inorganic pigment or dye. The charge control agent may be, for example, a metal-containing azo compound, a metal-containing salicylic acid derivative compound, inclusion compounds of polysaccharide and a compound resulting from the hydrophobization of a metallic oxide. Further, the wax is a natural wax such as carnauba wax and rice bran wax or a synthetic wax such as polypropylene, polyethylene and polyester.

A toner cartridge 17, which supplies toner for the developing device 14, is arranged above the image forming unit 10.

Paper feeding boxes 18 and 19 are arranged on the internal lower part of the image forming apparatus 1. Paper is fed from the paper feeding boxes 18 and 19. In addition, a finger tray 20, from where paper is fed, is arranged on one side of the image forming apparatus 1. The paper is conveyed upwards through a conveyance system 21, which comprises a conveyance roller pair 22, a resisting roller pair 23, a fixation roller pair 24 and a paper discharging roller pair 25. The conveyance system 21 further comprises a re-conveyance apparatus 26 for transferring on two sides of the paper.

During the forming process of an image, the light source 5 irradiates light towards the original on the Original Document Platform 2. The light is reflected from the original and received by the light receiving element 9 through the first, second and third reflecting mirrors so that the image of the original is read. Based on the information read, the laser unit 13 irradiates a laser beam 13a towards the surface of the photoconductive surface 11 which is negatively charged in advance by the charger 12. Thus, the surface potential of the photoconductive drum 11 is approximately 0 corresponding to the density of the image, thereby forming an electrostatic latent image in an area corresponding to the image part of the original. With the rotation of the photoconductive drum 11, the electrostatic latent image is moved to a position opposite to the developer 14, and absorbs toner at the position to form a toner image (visible image).

The paper fed from the paper feeding boxes 18 and 19 or the finger tray 20 is neatened by the resisting roller 23 and then transferred to the position between the photoconductive drum 11 and the transfer roller 15 to be transferred with the toner image on the photoconductive drum 11. The paper on which the toner image is transferred is conveyed to the fixation roller pair 24 and pressurized and heated here to fix the image thereon. The fixed paper is discharged onto the paper discharging tray 27 by the paper discharging roller pair 25.

On the other hand, the residual toner left on the surface of the photoconductive drum 11 instead of transferred to the paper is removed and recycled by the cleaner 16. Further, toner is supplemented from the toner cartridge 17 when the toner in the developing device 14 is consumed.

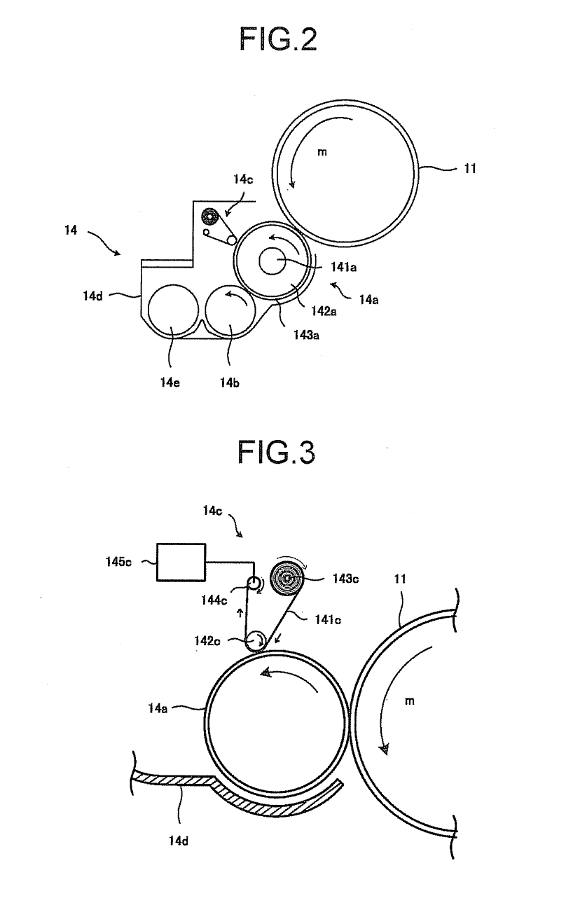

Next, the developing device 14 is described in detail with reference to FIG. 2 and FIG. 3. FIG. 2 is a diagram roughly showing the structure of the developing device 14 shown in FIG. 1, and FIG. 3 is a diagram showing main components of the developing device shown in FIG. 2.

The developing device 14, in which the single-component nonmagnetic toner is accommodated, comprises a developing container 14d, which comprises a developing roller 14a serving as a developer carrier for supplying toner for the photoconductive drum 11 serving as an image carrier, a toner supplying roller 14b for supplying toner for the developing roller 14a and a toner layer regulating member 14c for regulating the thickness of the toner layer supplied to the developing roller 14a to be uniform. Further, the developing device 14 comprises a stirring rod 14e for stirring the toner in the developer container 14d.

The developing roller 14a is provided with an elastic body layer 142a and an electric conductor layer 143a concentric with the elastic body layer on the periphery of a metal shaft 141a parallel to the axis of the photoconductive drum 11 and rotates in a direction opposite to the rotation direction (indicated by the arrow m) of the photoconductive drum 11 at a given speed. The metal shaft 141a is conductively connected with the electric conductor layer 143a. A developing bias power supply is connected with the metal shaft 141a. Toner is supplied to the developing roller 14a by the toner supplying roller 14b and the stirring rod 14e and formed into a thin uniform-thickness toner layer by the toner layer regulating member 14c. The toner layer formed on the developing roller 14a contacts the photoconductive drum 11 to develop the latent image on the photoconductive drum 11.

The toner supplying roller 14b and the developing roller 14a rotate towards the same direction to facilitate the frictional electrification of the toner in the developing container 14d and supply the toner onto the developing roller 14a.

The toner layer regulating member 14c comprises a sheet member 141c for regulating the thickness of the toner layer supplied onto the developing roller 14a, a pressing roller 142c serving as a pressing member for pressing the sheet member 141c to be connected with the developing roller 14a, a sheet member supplying shaft 143c for outputting the sheet member 141c and a sheet member rolling shaft 144c for rolling the sheet member 141c.

The sheet member 141c is almost as long as the axis direction (referred hereinafter to as a primary scanning direction) of the developing roller 14a. As the sheet member 141c, a silicon rubber sheet obtained by shaping silicon rubber into a sheet and a nickel film formed by plating nickel on a substrate such as a PET film in vacuum can be listed. The sheet member 141c is of any thickness that enables the sheet member to be rolled.

The sheet member supplying shaft 143c extends in the primary scanning direction to coil the sheet member 141c. The sheet member 141c can load or unload the sheet member supplying shaft 143c. A sheet member rolling shaft 144c also extends in the primary scanning direction as the sheet member supplying shaft 143c to coil the sheet member 141c between the pressing roller 142c and the developing roller 14a. The sheet member rolling unit 144c is driven by a rolling motor 145c. The sheet member rolling shaft 144c rolls up the sheet member 141c gradually for each preset number of the life (the number of the image forming to a transcriptional medium). That is, the new side of the sheet member 141c is pressed against the developing roller 14a for each number of the life. The speed (movement speed) at which the sheet member 141c is rolled is lower than the rotation speed (movement direction) of the developing roller 14a, specially, for example, the movement distance of the sheet member 141c is 1 mm when the drive distance of the developing roller 14a is 450,000 mm.

In this way, by the sheet member 14c is rolled every given number of the life, the pressed surface (pressed part) of the sheet member 141c for the developing roller 14a, that is, the polluted part caused by toner material, the abraded part of the sheet member 141c caused by an external additive such as inorganic oxide particles and the coarse large particles mingled and the like are moved to the side of the sheet member rolling sheet 144c so that the sheet member 141c in the pressed surface (pressed part) which contacts with the developing roller 14a is able to keep refreshed state.

With the structure above, the pollution caused by the toner to the toner layer regulating member and image quality problems, such as the blurring caused by abrasion, the difference in densities of solid images and a white stripe caused by the inclusion of coarse large particles, are prevented.

Embodiments are displayed to describe the embodiment more specifically. In addition, the ‘part’ mentioned hereinafter refers to a weight standard, if not specified particularly.

### Example of Preparation of Toner

| | |
|---|---|
| Polyester resin (binder resin) | 85 parts by weight |
| Crystalline polyester resin | 5 parts by weight |
| Ester wax | 3 parts by weight |
| Coloring agent (MA-100) | 6 parts by weight |
| Charge control agent | 1 part by weight |

The materials above are mixed by a Henschel mixer and then melted and kneaded by a two-shaft extruder. The melted and kneaded material is cooled, coarsely crushed by a hammer bill, and finely crushed and leveled by a jet mill to obtain powder having an average diameter of 7 um.

5.0 parts by weight of hydrophobic silica is added to and mixed with 100 parts by weight of the powder by a Henschel mixer to prepare the toner.

### Evaluation Test

By changing the toner layer regulating member, the following items are evaluated using the single-component nonmagnetic toner prepared in the way above under the following preparation conditions:

### Preparation Conditions

Linear pressure of the toner layer regulating member: 35N/m

Thickness of sheet (sheet member): 0.1mm

Sheet rolling speed: 1 mm rollsheet is rolled when drive distance of developing roller is 450, 000 mm.

### Evaluation Test

### White Stripe

After an original having a word print percentage of 8.0% is continuously copied onto A4 papers for 200,000 times, the original filled with white strips (strip having a width of above 0.1 mm) due to the fixation of the toner to the toner layer regulating member is set to be O, the original on which 1-3 white strips are generated is set to be Δ, and the original on which more than 3 white strips are generated is set to be ×. The result of the evaluation is presented in Table 1.

### Blurring

After an original having a word print percentage of 8.0% is continuously copied onto A4 papers for 200,000 times, the original having a blurring percentage of below 1.5% is set to be O, the original having a blurring percentage of 1.5%-3.0% is set to be Δ, and the original having a blurring percentage of above 3.0% is set to be ×. The result of the evaluation is presented in Table 1.

### Image Density (ID)

After an original having a word print percentage of 8.0% is continuously copied onto A4 papers for 200,000 times, the original having an image density difference (in the full image) of below 0.05% is set to be O, the original having an image density difference of 0.05%-0.09% is set to be Δ, and the original having an image density difference of above 0.10% is set to be x. The result of the evaluation is presented in Table 1. Further, the image density (ID) is measured using a reflection density meter (RD-19i, produced by Gretagmacbeth Company).

TABLE 1

| | | | | | | | Image density | |
|---|---|---|---|---|---|---|---|---|
| | | | | | | | difference | |
| | | | White stripe | | Blurring | | Initial | |
| | Toner layer | | Initial | | Initial | | stage | |
| | regulating | | stage | | stage | | (number | |
| | member | | (number of | 20K* | (number of | 20K* | of | 20K* |
| | shape | material | pieces: 0) | piece | pieces: 0) | piece | pieces: 0) | piece |
| Embod- | sheet | Silicon | ∘ | ∘ | ∘ | ∘ | ∘ | ∘ |
| iment 1 | | rubber | | | | | | |
| Embod- | sheet | Nickel | ∘ | ∘ | ∘ | ∘ | ∘ | ∘ |
| iment 2 | | | | | | | | |
| Comparative | blade | Silicon | ∘ | Δ | ∘ | x | ∘ | x |
| embod- | | rubber | | | | | | |
| iment 1) | | | | | | | | |
| Comparative | blade | Nickel | ∘ | x | ∘ | Δ | ∘ | Δ |
| embod- | | | | | | | | |
| iment 2) | | | | | | | | |

*K = 1000

As shown in Table 1, in the embodiments 1 and 2 of the developing device in which the toner layer regulating member is set to be a sheet, the results of the evaluations on white strip, blurring and image density difference are good. On the other hand, in the comparative embodiments 1 and 2 of the developing device in which the toner layer regulating member is set to be a blade, the results of the evaluations on white strip, blurring and image density difference are inferior to those obtained in embodiments 1 and 2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions the accompanying claims and their equivalents are intended to cover such forms or modifications as would fall within the scope and spirit of the inventions.

What is claimed is:

1. A developing device, comprising:
a developer carrier arranged opposite to an image carrier on which an electrostatic latent image is formed and configured to supply toner for the electrostatic latent image; and
a toner layer regulating member configured to be pressed against the developer carrier to regulate the thickness of a toner layer on the developer carrier and the pressured surface of the developer carrier can be moved.

2. The developing device according to claim 1, wherein
the toner layer regulating member includes a pressing member, and
the sheet member is pressed against the developer carrier by the pressing member.

3. The developing device according to claim 1, wherein
the toner layer regulating member includes a sheet member supplying shaft and a sheet member rolling shaft,
the sheet member rolled on the sheet member supplying shaft is wound onto the sheet member rolling shaft to move the pressed surface.

4. The developing device according to claim 1, wherein
the movement speed of the sheet member is lower than that of the developer carrier.

5. The developing device according to claim 1, wherein
the toner is a single-component nonmagnetic toner.

6. An image forming apparatus, includes an image carrier and a developing device for supplying toner to an electrostatic latent image formed on the image carrier, wherein
the developing device includes:
a developer carrier configured to supply toner to the electrostatic latent image; and
a toner layer regulating member configured to be pressed against the developer carrier to regulate the thickness of a toner layer on the developer carrier and the pressured surface of the developer carrier can be moved.

7. The image forming apparatus according to claim 6, wherein
the toner layer regulating member includes a pressing member, and
the sheet member is pressed against the developer carrier by the pressing member.

8. The image forming apparatus according to claim 6, wherein
the toner layer regulating member includes a sheet member supplying shaft and a sheet member rolling shaft,
the sheet member rolled on the sheet member supplying shaft is wound onto the sheet member rolling shaft to move the pressed surface.

9. The image forming apparatus according to claim 6, wherein
the movement speed of the sheet member is lower than that of the developer carrier.

10. The developing device according to claim 6, wherein
the toner is a single-component nonmagnetic toner.
